(19) United States
(12) Patent Application Publication
(10) Pub. No.: US 2015/0343479 A1
(43) Pub. Date: Dec. 3, 2015

(54) CONTROL METHOD AND CONTROL SYSTEM USED FOR ROLLER COATING PRINTING PRODUCTION LINE

(71) Applicant: LIAONING CHAOSHUO TOMA TECHNOLOGY STEEL PLATE PRINTING CO., LTD., Yingkou City, Liaoning (CN)

(72) Inventors: Yueping TANG, Yingkou City, Liaoning (CN); Jianping ZHOU, Yingkou City, Liaoning (CN); Liang WU, Yingkou City, Liaoning (CN)

(73) Assignee: LIAONING CHAOSHUO TOMA TECHNOLOGY STEEL PLATE PRINTING CO., LTD., Yingkou City, Liaoning (CN)

(21) Appl. No.: 14/647,155

(22) PCT Filed: Jun. 28, 2013
(86) PCT No.: PCT/CN2013/078383

§ 371 Date: Jul. 21, 2015

(30) Foreign Application Priority Data
Nov. 23, 2012 (CN) 201210481661.1

(51) Int. Cl. B05C 1/08; B41F 33/16; B41F 3/00

(52) U.S. Cl. CPC B05C 1/0873; B41F 3/00; B41F 33/16

(57) ABSTRACT

The present invention provides a control method used in a roller coating production line, wherein by calculating and controlling the theoretical roll surface linear velocity and actual roll surface linear velocity of each roller in a roller coating unit, the rotational speed of each roller is kept consistent with the process speed, increasing production efficiency. At the same time, calculating a pattern misplacement distance in repeat printing by means of code recognition technology, thereby adjusting the rotational speed of each roller, achieves lifelike and holonomic patterning in multicolored printing and extends the printed length of the pattern.

### FIELD OF INVENTION

The present invention relates to a control method and a control system used for roller coating printing production line, belonging to the field of variegated steel plate manufacturing.

### BACKGROUND OF THE INVENTION

Colored coating steel plate (commonly known as variegated steel plate) refers to that a metal substrate is treated by surface pretreatment prior to painting such as surface degreasing treatment and surface passivating treatment through a continuous unit, and then is coated with one-layer or multilayer of organic coatings on the surface, thus forming a composite material.

In order to coat multicolored patterns, the color of coating is required to be changed for several times a day for a majority of coating production line, and in order to realize the purpose of non-stop production, non-decrease yield and quick color change, generally two devices for fine coating are arranged at the front position of coating layer of the machine for fine coating of the processing line, wherein, device 1 is a single-head device for fine coating, and device 2 is a dual-head device for fine coating, which is arranged under machine 1, and when one device for fine coating coats a strip steel, the other one prepares for printing the next color, however, the above processing line is lack of a positioning system used for determining a relative position of various color, which is just used for coating a regular pattern, but cannot produce an irregular one.

The intaglio printing machine used in the prior art of roller coating type for producing variegated steel plate with multicolored patterns comprises a feeding equipment, used for providing paints; a suction roller, whose circumferential surface is in connection with the feeding equipment, and has a plurality of recesses adapted for being filled with paints for forming an image area; and a rubber coating roller, with its circumferential surface in connection with the suction roller, and used for receiving and transferring the image area formed by the paints on the coating roller onto a steel plate to form desired multicolored patterns.

However, during the process of using the intaglio printing machine, the applicant found out that the roller surface linear velocity of the suction roller and the rubber coating roller are frequently inconsistent with the process speed of the whole production line, and the whole production line is lack of a control system for on-line adjusting the rotation speed of the suction roller and the rubber coating roller, so the whole production line has to be stopped for adjustment after operation for a period of time, thus affecting the efficiency of the whole production line. If the production line is not stopped for adjustment, the steel strip transporting speed would be inconsistent with the roller surface linear velocity of each roller, thus frequently causing the steel strip unable to be coated at a designated position thereof. Besides, in order to print multicolor patterns, a plurality of roller coating units are required for coordinated operation. However, the above mentioned intaglio printing machine in the prior art is lack of a control system for allowing a continuous production between adjacent roller coating units, so workers need observe by human eyes if a first roller coating unit has completed coating of one color, and if yes, an adjacent roller coating unit will be started by manual work, thus it is unable to realize a continuous production between the adjacent roller coating units. At the same time, due to lack of the control system for adjusting the rotate speed of the suction roller and the coating roller, it is unable to realize error revision when misplacement occurs between the patterns printed by the adjacent roller coating units.

### SUMMARY OF THE INVENTION

Therefore, a first technical problem to be solved by the present invention is to provide a control method used for roller coating printing production line, by which the roller surface linear velocity of each roller of a roller coating unit is able to be adjusted to be consistent with the rotation speed of the process, thus improving the production efficiency.

A second technical problem to be solved by the present invention is to provide a control method used for continuously roller coating printing production line on the processing line of adjacent roller coating units.

A third technical problem to be solved by the present invention is to provide a control method used for continuously roller coating printing production line to be able to realize error correction when misplacement occurs between the patterns and produce a lifelike and holonomic patterns.

Simultaneously, the present invention further provides a control system used for roller coating printing production line to match the use of the above control method.

In order to solve one of the above mentioned technical problems, the present invention provides a control method used for roller coating printing production line, comprising the steps: S1. inputting data of diameter of each roller and a process speed of the first roller coating unit into a PLC control module, then calculating out theoretical roller surface linear velocity of each roller by the PLC control module according to the process speed and the diameter of each roller, allowing the theoretical roller surface linear velocity of each roller to be consistent with the process speed, and outputting the calculated theoretical roll surface linear velocity signal of each roller into a servo control module having an encoder; S2. receiving the theoretical roll surface linear velocity signal of each roller by the servo control module from the PLC control module and driving each roller according to the theoretical roll surface linear velocity signal; S3. collecting actual roller surface linear velocity of each roller by the encoder and outputting the actual roller surface linear velocity signal of each roller into the PLC control module; S4. according to the received actual roller surface linear velocity signal and theoretical roller surface linear velocity signal of each roller, adjusting current frequency of electrical machine, driving each roller and adjusting the actual roller surface linear velocity of each roller to be consistent with the theoretical roller surface linear velocity of each roller by the PLC control module, thereby completing the roller coating transfer of the first roller coating unit.

In a class of embodiments, in the step S1, distance data between the first roller coating unit and the second roller coating unit is input into the PLC control module, and on the basis of the process speed and the distance data, the PLC control module is adapted for calculating out a time to start the second roller coating unit, and starts the second roller coating unit according to the time, and then the second roller coating transfer of the second roller coating unit is completed.

In a class of embodiments, after completing the second roller coating transfer of the second roller coating unit, the printed patterns are collected by a code recognition module, and the pattern misplacement distance is determined by computer recognition, and then the process speed of the corresponding roller coating unit is revised.

In a class of embodiments, the printed patterns are collected by a digital video comprised in the code recognition module.

In a class of embodiments, a control system used for roller coating printing production line comprises a PLC control module, adapted for storing data of diameter of each roller and a process speed of a first roller coating unit, calculating out theoretical roller surface linear velocity of each roller according to the process speed and the diameter of each roller, allowing the theoretical roller surface linear velocity of each roller to be consistent with the process speed, and respectively outputting the calculated theoretical roll surface linear velocity signal of each roller; a servo control module, adapted for receiving the theoretical roll surface linear velocity signal of each roller from the PLC control module and driving each roller according to the signal, and having an encoder used to collect actual roller surface linear velocity of each roller, output the actual roller surface linear velocity signal of each roller into the PLC control module and allow the PLC control module to adjust current frequency of electrical machine to drive each roller, according to the received actual roller surface linear velocity signal and theoretical roller surface linear velocity signal of each roller, so as to allow the actual roller surface linear velocity of each roller to be consistent with the theoretical roller surface linear velocity of each roller, thereby completing the roller coating transfer of the first roller coating unit.

In a class of embodiments, distance data between the first roller coating unit and the second roller coating unit is input into the PLC control module, and on the basis of the process speed and the distance data, the PLC control module is adapted for calculating out a time to start the second roller coating unit.

In a class of embodiments, a code recognition module is further comprised in the control system to collect the printed patterns, and the pattern misplacement distance is determined by computer recognition, and then the process speed of the corresponding roller coating unit is revised.

In a class of embodiments, the PLC control module is a servo motor.

In a class of embodiments, the servo motor has a data collection unit used for collecting the process speed signal, a calculating unit used for calculating the theoretical roll surface linear velocity and a comparing unit used for comparing the theoretical roll surface linear velocity with the actual roll surface linear velocity.

The present invention has following advantages compared with the prior arts:

1. The present invention provides a control method used for roller coating printing production line. for the first transfer, on one hand, the PLC control module of the servo control module collects the process speed and the rotation speed of each roller of the roller coating unit, calculates out the theoretical roller surface linear velocity and makes the theoretical roller surface linear velocity be consistent with the process rotation speed; on the other hand, the actual roller surface linear velocity of each roller of the roller coating unit is collected by a servo control module, and the signal of the actual roller surface linear velocity is input into the PLC control module, so that the PLC control module can compare the actual roller surface linear velocity with the theoretical roller surface linear velocity, and adjust current frequency until the actual roller surface linear velocity is consistent with the theoretical roller surface linear velocity. In the above mentioned control method, the actual roller surface linear velocity is adjusted to be consistent with the theoretical roller surface linear velocity which is consistent with the process speed, thus ensuring that the actual roller surface linear velocity is consistent with the process rotation speed, so there is no need to stop the line for adjusting in the production process, thus increasing the production efficiency.

2. The present invention provides a control method used for roller coating printing production line. the distance data between the first roller coating unit and the second roller coating unit is also input into the PLC control module, and on the basis of the process speed and the distance data, the PLC control module is able to calculate out a time to start the second roller coating unit. Once the production line is determined, the distance between adjacent units can be determined. The distance data is input into the PLC control module in advance, and then according to the process speed and distance data, the PLC control module calculates out the time to start the next roller coating production line. Then the time for starting the next roller coating unit is able to be preset, and the next roller coating production line is allowed to be started within a preset time, so a continuous production between the adjacent roller coating units is realized, and the production efficiency is further improved.

3. The present invention provides a control method used for roller coating printing production line, and further comprises a code recognition module. The printed patterns are collected by the code recognition module, and the pattern misplacement distance is determined by computer recognition, and then the process speed of the corresponding roller coating unit is revised. After the next roller coating production line is started and the second transfer is completed, the printed patterns are collected by the code recognition module and the pattern misplacement distance is determined by the computer recognition, and then the rotation speed of each roller is revised in accordance with the pattern misplacement distance, so that the pattern misplacement can be revised. The above process can be circularly performed, hence ensuring lifelike and complete printed patterns. In addition, the length of the printed patterns is extended significantly by using the code recognition module.

### BRIEF DESCRIPTION OF THE DRAWINGS

In order to make the present invention more easily and clearly understood, the invention is further described below in conjunction with the detailed embodiments and the drawings, wherein,

FIG. 1 is a schematic view of a roller coating unit of the present invention;

FIG. 2 is a schematic view of a roller coating unit with a cleaning device of the present invention;

FIG. 3 is a workflow chart of a control method of the present invention.

The reference numbers in the drawings represent:

81—feeding equipment; 82—suction roller; 83—coating roller; 84—first scraper; 85—second scraper; 86—cleaning device; 861—liquid feed tank; 862—transfer pump; 863—transfer pipe; 864—spay pipe; 865—spay hole; 867—recovery tank; 868—support roller.

### DETAILED DESCRIPTION OF THE EMBODIMENTS

### Embodiment 1

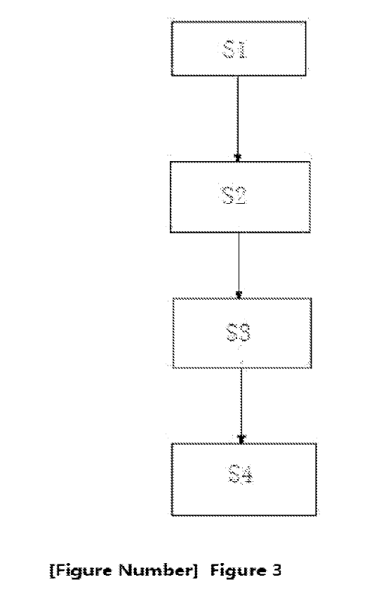

As shown in FIG. 3, the present embodiment provides a control method used for roller coating printing production line comprising the following steps:

S1. Inputting data of diameter of each roller and a process speed of the first roller coating unit into a PLC control module, whereby calculating out theoretical roller surface linear velocity of each roller by the PLC control module (Firstly calculating out the theoretical rotation speed, theoretical rotation speed=process speed/π*diameter of each roller, then calculating out the theoretical roller surface linear velocity according to the theoretical rotation speed: theoretical roller surface linear velocity=theoretical rotation speed*roller diameter*π), allowing the theoretical roller surface linear velocity of each roller to be consistent with the process speed, and outputting the calculated theoretical roll surface linear velocity signal of each roller into a servo control module having an encoder;

S2. receiving the theoretical roll surface linear velocity signal of each roller by the servo control module from the PLC control module and driving each roller according to the theoretical roll surface linear velocity signal;

S3. collecting actual roller surface linear velocity of each roller by the encoder and outputting the actual roller surface linear velocity signal of each roller into the PLC control module;

S4. according to the received actual roller surface linear velocity signal and theoretical roller surface linear velocity signal of each roller, adjusting current frequency of electrical machine driving each roller and adjusting the actual roller surface linear velocity of each roller to be consistent with the theoretical roller surface linear velocity of each roller by the PLC control module, thereby completing the roller coating transfer of the first roller coating unit.

In the present embodiment, in order to realize continuous operation of adjacent roller coating units on line, in the step S1, distance data between the first roller coating unit and the second roller coating unit is input into the PLC control module, and on the basis of the process speed and the distance data, the PLC control module is adapted for calculating out a time to start the second roller coating unit, and starts the second roller coating unit according to the time, and then the second roller coating transfer of the second roller coating unit is completed.

In the present embodiment, in order to print irregular long patterns, after completing the printing of the second roller coating unit, that is, after the step S4, the printed patterns are collected by a code recognition module, and the pattern misplacement distance is determined by a computer recognition system, and then the process speed of the corresponding roller coating unit is revised. The revision process is described in detail as below. If the actual position of a latter printed color in the patterns collected by the code recognition module misplaces a distance from the predetermined position of the latter printed color relative to the former printed color, for example, the actual position locates at 10 mm ahead of the predetermined position, which indicates that the actual process speed (denoted by V1) of the roller delivering the steel strip speeds up 10 mm per unit time relative to the theoretical process speed (denoted by V2), that is at this time, V2=V1-10, thus calculating out V2. Then the calculated V2 is converted into the theoretical rotation speed of the roller (denoted by N) via the formula N=V2/π*roller diameter, thereby adjusting the current frequency of the corresponding electric machine in accordance with rotation speed N, thus the rotation speed of the corresponding roller will be adjusted, and the process speed will be further adjusted, and finally the pattern misplacement accuracy is controlled within ±0.6 millimeter. This adjusting process is a dynamic and repeated process. Herein, the printed patterns are collected by a digital video comprised in the code recognition module.

It should be noted that, the above control method may be applied in the machine units for multicolored roller coating transfer, but there is no limitation to the specific structural of the roller coating transfer machine units.

Furthermore, the above control system of the present embodiment adopts two roller coating units at back and forth, and can produce two-color patterned variegated steel plate. While on the basis of the control method of the present embodiment, the person skilled in the art can perform modifications so as to produce variegated steel plate with patterns in three-, four-, five- or more color.

### Embodiment 2

The present embodiment provides a control system used for the control method in embodiment 1, comprising a PLC control module, adapted for storing data of diameter of each roller and a process speed of a first roller coating unit, calculating out theoretical roller surface linear velocity of each roller according to the process speed and the diameter of each roller, allowing the theoretical roller surface linear velocity of each roller to be consistent with the process speed, and respectively outputting the calculated theoretical roll surface linear velocity signal of each roller; and a servo control module, adapted for receiving the theoretical roll surface linear velocity signal of each roller from the PLC control module and driving each roller according to the signal, and having an encoder used to collect actual roller surface linear velocity of each roller, output the actual roller surface linear velocity signal of each roller into the PLC control module and allow the PLC control module to adjust current frequency of electrical machine to drive each roller, according to the received actual roller surface linear velocity signal and theoretical roller surface linear velocity signal of each roller, so as to allow the actual roller surface linear velocity of each roller to be consistent with the theoretical roller surface linear velocity of each roller, thereby completing the roller coating transfer of the first roller coating unit.

In the present embodiment, in order to realize continuous operation of adjacent roller coating units on line, distance data between the first roller coating unit and the second roller coating unit is input into the PLC control module, and on the basis of the process speed and the distance data, the PLC control module is adapted for calculating out a time to start the second roller coating unit.

In the present embodiment, the PLC control module is a servo motor which has a data collector used for collecting the process speed signal, a calculator used for calculating out the theoretical roll surface linear velocity and a comparator used for comparing the theoretical roll surface linear velocity with the actual roll surface linear velocity.

In the present embodiment, in order to print irregular long patterns, a code recognition module is further comprised and the printed patterns are collected by the code recognition module, and a pattern misplacement distance is determined by computer recognition, and then the process speed of the corresponding roller coating unit is revised.

It should be noted that, the above control system may be applied in machine units for multicolored roller coating transfer, but there is no limitation to the specific structural of the machine units.

Furthermore, the above control system of the present embodiment adopts two roller coating units at back and forth, and can produce two-color patterned variegated steel plate. While on the basis of the control method of the present embodiment, the person skilled in the art can perform modifications so as to produce variegated steel plate with patterns in three-, four-, five- or more color.

### Embodiment 3

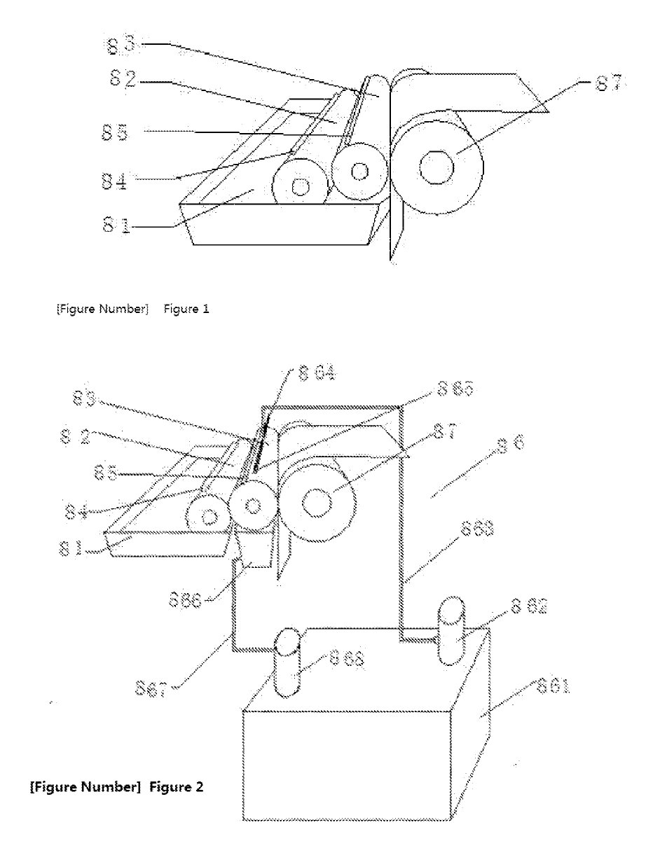

As shown in FIGS. 1 and 2, the present embodiment provides a roller coating unit used in the control method of the embodiment 1 and the control system of the embodiment 2. The roller coating unit comprises a feeding equipment 81 used for providing paints; a suction roller 82, whose circumferential surface is in connection with the feeding equipment 81, and has a plurality of recesses adapted for being filled with paints for forming an image area; a rubber-coating roller 83, with its circumferential surface in connection with the suction roller 82, used for receiving and transferring the image area formed by the paints on the coating roller 83 onto a steel plate; a first scraper 84, arranged on a first scraper support and contacting with the suction roller 82 at a specific angle, used for scraping off paints outside the image area on the suction roller 82; and a second scraper 85, arranged on the second scraper support and contacting with the coating roller at a specific angle, used for scraping off residuary paints on the rubber coating roller 83 after transfer.

In the present embodiment, particularly, the first scraper 84 contacts with the suction roller 82 at an angle less than 30 degrees, and the second scraper 85 contacts with the coating roller 83 at an angle more than 30 degrees. During intaglio printing process, paints that need to be scraped off are located on different positions at the same time, so the first scraper 84 and the second scraper 85 are set at different angles, thus ensuring paints on the suction roller 82 and the coating roller 83 can be scraped off at the same time.

In the present embodiment, the roller coating unit 8 further comprises a cleaning device 86. The cleaning device 86 comprises a liquid feed tank 861, a transfer pump 862 used for pumping the cleaning liquid in the liquid feed tank 861, a cleaning liquid transfer pipe 863 communicated with the cleaning liquid transfer pump 862, and a spay pipe 864 communicated with the cleaning liquid transfer pipe. The spay pipe 864 is arranged above the rubber coating roller 83 in the axial direction and has a plurality of spay holes 865 thereon.

In the present embodiment, the cleaning device 86 further comprises a cleaning liquid recovery tank 866, arranged below the coating roller 83 and connected with a recovery pipe 867 leading to the liquid feed tank 861. A filter 868 is arranged between the recovery pipe 867 and the liquid feed tank 861.

Certainly, the servo control module of the present embodiment can also be used for printing a pattern in three or four color.

The specific application process of the roller coating unit using the control method of embodiment 1 is that:

S1. inputting the diameters of the suction roller 82 (see FIG. 1, FIG. 2), the coating roller 83 and the process speed of the first roller coating unit into the PLC control module, then calculating out the theoretical roller surface linear velocity of the suction roller 82 and the coating roller 83 by the PLC control module according to the process speed and the diameters of the suction roller 82 and the coating roller 83, allowing the theoretical roller surface linear velocity of the suction roller 82 and the coating roller 83 to be consistent with the process speed, and outputting the calculated theoretical roller surface linear velocity signal of the suction roller 82 into a first servo control module having a first encoder, and outputting the theoretical roller surface linear velocity signal of the coating roller 83 into a second servo control module having a second encoder;

S2, receiving the theoretical roller surface linear velocity signal of the suction roller 82 by the first servo control module from the PLC control module and driving the suction roller 82 according to the signal; and receiving the theoretical roller surface linear velocity signal of the coating roller 83 by the second servo control module from the PLC control module and driving the coating roller 83 according to the signal;

S3, collecting the actual roller surface linear velocity of the suction roller 82 by the first encoder and outputting the actual roller surface linear velocity signal of the suction roller 82 into the PLC control module, and collecting the actual roller surface linear velocity of the coating roller 83 by the second encoder and outputting the actual roller surface linear velocity signal of the coating roller 83 into the PLC control module;

S4. according to the received actual roller surface linear velocity signal and the theoretical roller surface linear velocity signal of the suction roller 82 and the coating roller 83, adjusting current frequency of electrical machine driving each roller, and adjusting the actual roller surface linear velocity of the suction roller 82 and the coating roller 83 to be consistent with the theoretical roller surface linear velocity of the suction roller 82 and the coating roller 83 by the PLC control module, thereby completing the roller coating transfer of the first roller coating unit.

In the present embodiment, in order to realize continuous operation of adjacent roller coating units on line, in the step S1, distance data between the first roller coating unit and the second roller coating unit is input into the PLC control module, and on the basis of the process speed and the distance data, the PLC control module is adapted for calculating out a time to start the second roller coating unit, and starts the second roller coating unit according to the time, and then the second roller coating transfer of the second roller coating unit is completed.

In the present embodiment, in order to print irregular long patterns, after completing the printing of the second roller coating unit, the printed patterns are collected by a code recognition module, and a pattern misplacement distance is determined by computer recognition, and then the rotate speed of the corresponding roller coating unit is revised. Herein, the printed patterns are collected by a digital video comprised in the code recognition module.

While particular embodiments of the invention have been shown and described, it will be obvious to those skilled in the art that changes and modifications may be made without departing from the invention in its broader aspects, and, therefore, the aim of the appended claims is to cover all such changes and modifications as fall within the true spirit and scope of the invention.

1-9. (canceled)

10. A control method used for roller coating printing production line, comprising the following steps of,
S1. inputting data of diameter of each roller and a process speed of said first roller coating unit into a PLC control module, then calculating out theoretical roller surface linear velocity of each roller by the PLC control module according to the process speed and the diameter of each roller, allowing the theoretical roller surface linear velocity of each roller to be consistent with the process speed, and outputting the calculated theoretical roll surface linear velocity signal of each roller into a servo control module having an encoder;
S2. receiving said theoretical roll surface linear velocity signal of each roller by the servo control module from the PLC control module and driving each roller according to the theoretical roll surface linear velocity signal;
S3. collecting actual roller surface linear velocity of each roller by the encoder and outputting the actual roller surface linear velocity signal of each roller into the PLC control module;
S4. according to the received actual roller surface linear velocity signal and theoretical roller surface linear velocity signal of each roller, adjusting current frequency of electrical machine driving each roller and adjusting the actual roller surface linear velocity of each roller to be consistent with the theoretical roller surface linear velocity of each roller by the PLC control module, thereby completing the roller coating transfer of the first roller coating unit;
in the step S1, distance data between the first roller coating unit and the second roller coating unit is input into the PLC control module, and on the basis of the process speed and the distance data, the PLC control module calculates out a time to start the second roller coating unit, and starts the second roller coating unit according to the time, and then the second roller coating transfer of the second roller coating unit is completed.

11. The control method of claim 10, wherein, after completing the second roller coating transfer of the second roller coating unit, the printed patterns are collected by a code recognition module, and a pattern misplacement distance is determined by computer recognition, and then the process speed of the corresponding roller coating unit is revised.

12. The control method of claim 11, wherein, the printed patterns are collected by a digital video comprised in the code recognition module.

13. A control system used for roller coating printing production line, comprising,
a PLC control module, adapted for storing data of diameter of each roller and a process speed of a first roller coating unit, calculating out theoretical roller surface linear velocity of each roller according to the process speed and the diameter of each roller, allowing the theoretical roller surface linear velocity of each roller to be consistent with the process speed, and respectively outputting the calculated theoretical roll surface linear velocity signal of each roller;
a servo control module, adapted for receiving the theoretical roll surface linear velocity signal of each roller from the PLC control module and driving each roller according to the signal, and having an encoder used to collect actual roller surface linear velocity of each roller, output the actual roller surface linear velocity signal of each roller into the PLC control module and allow the PLC control module to adjust current frequency of electrical machine to drive each roller, according to the received actual roller surface linear velocity signal and theoretical roller surface linear velocity signal of each roller, so as to allow the actual roller surface linear velocity of each roller to be consistent with the theoretical roller surface linear velocity of each roller, thereby completing the roller coating transfer of the first roller coating unit;
distance data between the first roller coating unit and the second roller coating unit is input into the PLC control module, and on the basis of the process speed and the distance data, the PLC control module is adapted for calculating out a time to start the second roller coating unit.

14. The control system of claim 13, wherein, said PLC control module is a servo motor.

15. The control system of claim 14, wherein, said servo motor has a data collector used for collecting the process speed signal, a calculator used for calculating out the theoretical roll surface linear velocity and a comparator used for comparing the theoretical roll surface linear velocity with the actual roll surface linear velocity.

16. The control system of claim 13, wherein, a code recognition module is further comprised to collect the printed patterns, and the pattern misplacement distance is determined by computer recognition, and then the process speed of the corresponding roller coating unit is revised.

17. The control system of claim 16, wherein, said PLC control module is a servo motor.

18. The control system of claim 17, wherein, said servo motor has a data collector used for collecting the process speed signal, a calculator used for calculating out the theoretical roll surface linear velocity and a comparator used for comparing the theoretical roll surface linear velocity with the actual roll surface linear velocity.
